(19) United States
(12) Patent Application Publication
(10) Pub. No.: US 2026/0307495 A1
(43) Pub. Date: Oct. 8, 2026

(54) Method for Operating a High-Voltage System of a Mobile Work Machine

(71) Applicant: Robert Bosch GmbH, Stuttgart (DE)

(72) Inventors: Dominik Thomas Hoffmann, Urmitz (DE); Lothar Jahn, Ulm (DE); Matthias Jerg, Neu-Ulm (DE)

(21) Appl. No.: 19/639,243

(22) Filed: Apr. 5, 2026

(30) Foreign Application Priority Data
Apr. 8, 2025 (DE) 10 2025 113 694.7

(51) Int. Cl. B60L 3/04; B60R 16/023; B60R 16/033; E02F 9/20

(52) U.S. Cl. CPC B60L 3/04; B60R 16/0231; B60R 16/033; B60L 2200/40; E02F 9/2091

(57) ABSTRACT

A method for deactivating a high-voltage system of a mobile work machine is disclosed. The high-voltage system includes a voltage source, an intermediate circuit connected to the voltage source and additionally at least two high-voltage components connected to the intermediate circuit, which components are configured to exchange power with the intermediate circuit. The method includes the following, initiated in the order indicated, (a) deactivating the at least two high-voltage components so that power flows between the high-voltage components and the intermediate circuit are minimized, wherein deactivating occurs at least partially sequentially in an order, (b) deactivating the voltage source and/or decoupling the voltage source from the intermediate circuit, and (c) actively discharging the intermediate circuit and associated high-voltage components so that a voltage of the intermediate circuit is set to a value below a voltage limit.

This application claims priority under 35 U.S.C. § 119 to application no. DE 10 2025 113 694.7, filed on Apr. 8, 2025 in Germany, the disclosure of which is incorporated herein by reference in its entirety.

The present disclosure relates to a method for operating a high-voltage system of a mobile work machine and a corresponding work machine.

### BACKGROUND

The present disclosure relates to a method for deactivating a high-voltage system in a mobile work machine. High-voltage systems are found in a variety of mobile work machines, for example wheel loaders and excavators, particularly when an electric traction drive is employed in the mobile work machine. Deactivation of the high-voltage system is relevant in two main applications: on the one hand, a normal deactivation when the mobile work machine stops at the end of work and on the other hand, a forced deactivation during operation when there is a relevant fault.

Specific requirements for a method for deactivation are derived from these use cases. In particular, these requirements include a coordinated deactivation of all high-voltage components in order to avoid damage due to inadmissibly high currents or voltages and to minimize wear. In addition, rapid deactivation in response to failure conditions is important, although undesirable wear of the high-voltage system may occur. Finally, the method is intended to be adaptable to different architectures of high-voltage systems of different mobile work machines.

The prior art currently does not offer a solution that satisfies all of the stated requirements. Known methods often show weaknesses with respect to coordinating the shutdown of the individual high-voltage components, avoiding inadmissibly high currents and voltages, or adaptability to different configurations of mobile work machines. There is therefore a need for a method that enables safe, fast, and low-wear deactivation of a high-voltage system regardless of the particular type of machine. The disclosure addresses this gap in the prior art and offers a novel method with improved properties.

### SUMMARY

In accordance with one embodiment of the present disclosure, a method for deactivating a high-voltage system of a mobile work machine, for example a wheel loader or an excavator, is provided, wherein the high-voltage system comprises a voltage source, an intermediate circuit connected to the voltage source and additionally at least two high-voltage components connected to the intermediate circuit, which components are configured to exchange power with the intermediate circuit, characterized in that the method comprises the following steps, initiated in the order indicated:
a) deactivating the at least two high-voltage components so that power flows between the high-voltage components and the intermediate circuit are minimized, wherein deactivating occurs at least partially sequentially in a specified order such that functional dependencies among the high-voltage components or dependencies among functions of the mobile work machine can be considered; it may be provided that deactivating a high-voltage component comprises placing the component in a ready mode or standby mode;
b) deactivating the voltage source and/or decoupling the voltage source from the intermediate circuit, for example by opening the battery contactors;
c) actively discharging the intermediate circuit and associated high-voltage components so that a voltage of the intermediate circuit is set to a value below a voltage limit, preferably a value below 60 Volts.

“High voltage” is a term used in vehicle technology to refer to DC voltages over 60 Volts and AC voltages over 30 Volts. The high-voltage system according to the disclosure is preferably operated at a voltage of at least 400 Volts, more preferably at least 800 Volts. The high-voltage system according to the disclosure can thus enable a particularly efficient supply of power to the high-voltage components via the intermediate circuit.

The at least partially sequential deactivation of high-voltage components in a specified order according to the disclosure is advantageous, because in this way the best possible functionality of the mobile work machine is enabled during the deactivation of the high-voltage system. This is particularly important when deactivation is not triggered by the driver of the mobile work machine, but by, for example, detecting a fault in the high-voltage system as the mobile work machine moves. For example, in such a situation, the method according to the present disclosure allows a steering device of the mobile work machine to remain as functional as possible during deactivation so that the driver of the mobile work machine is enabled to avoid dangerous situations during deactivation. In addition, the at least partially sequential deactivation of high-voltage components in a specified order enables deactivation with as low wear as possible, for example by ensuring that a cooling device operated with high-voltage components remains functional as long as possible.

Preferably, the voltage source is configured as a battery or as a power converter, representing proven voltage sources for high-voltage systems. The power converter may be a DC-DC converter that converts the DC voltage of a power source, for example, a battery, into the DC voltage of the intermediate circuit. The power converter may be a bidirectional AC-DC converter, a rectifier, or an inverter arranged between a generator connected to an internal combustion engine and the intermediate circuit.

According to an embodiment of the present disclosure, a method is provided for a high-voltage system in which at least two of the high-voltage components are functionally dependent on one another so that deactivating a first high-voltage component impairs a function of a second high-voltage component. The method according to the disclosure is particularly advantageous for such a high-voltage system, because such a functional dependency can be considered in a specified order due to the at least partially sequential deactivation of the high-voltage components. In this way, impairment of a function of a high-voltage component can be avoided so that as good a functionality of the high-voltage system as possible is enabled.

Preferably, in step a), at least one high-voltage component is deactivated depending on the progress of deactivating another high-voltage component. For example, it may be provided that a second high-voltage component will not be deactivated until a first high-voltage component has already been deactivated. Such sequential deactivation is advantageous because it allows for controlled deactivation of the high-voltage system with reproducible behavior of the mobile work machine. In this way, the driver of the mobile work machine can optimally adjust to the process of deactivation so that hazardous situations can be avoided.

According to a preferred embodiment of the present disclosure, in step a), at least one high-voltage component is deactivated while taking into account a time interval. Such consideration of time intervals is advantageous, as in this way the method can be quickly performed. In particular, if deactivation of the high-voltage system has been triggered by detection of a fault, rapid deactivation may be important to avoid personal injury or damage to the mobile work machine. For example, it may be provided that a particular high-voltage component is deactivated at the latest when a specified time interval has elapsed since the start of step a). In this way, it can also be ensured that, in step a), the deactivation of all high-voltage components has been initiated within a certain period of time.

It is advantageous if, in step b), the decoupling of the voltage source from the intermediate circuit is caused by the opening of at least one contactor, since contactors are proven devices for electrical decoupling.

According to a preferred embodiment of the present disclosure, step b) is performed when step a) has caused each of the power flows between the at least two high-voltage components and the intermediate circuit to be set to zero, or to a value below a power threshold. Thus, it is indirectly ensured that the power flow between the voltage source and the intermediate circuit has been set to zero or to a value below a power threshold when step b) is performed. In this way, the occurrence of impermissibly high voltages or currents during the execution of step b) can be avoided, so that wear on the high-voltage system is minimized. For example, unacceptably high voltages or currents may be caused by opening battery contactors that are energized upon opening.

According to an embodiment of the present disclosure, step b) is performed when step a) has caused the power flow between the voltage source and the intermediate circuit to be set to zero, or to a value below a power threshold. Likewise, in this way, the occurrence of impermissibly high voltages or currents during the execution of step b) can be avoided, so that wear on the high-voltage system is minimized.

According to an embodiment of the present disclosure, step b) may be performed if there is still a power flow between the voltage source and the intermediate circuit. Such an approach is advantageous with regard to the speed of the method.

According to an embodiment of the present disclosure, step b) is performed at the latest when a specified time interval has elapsed since the execution of step a). This is advantageous because, in this way, the maximum duration for performing the method according to the disclosure can be controlled.

According to a preferred embodiment of the present disclosure, in step c) the voltage limit for actively discharging the intermediate circuit is in a range of 50 Volts to 70 Volts, wherein preferably the voltage limit is 60 Volts. The mentioned voltage limits for active discharging are advantageous because by lowering the voltage to a value below the voltage limit, hazards to persons due to electric shocks are limited.

It is advantageous if step c) is performed when the voltage source has been deactivated or decoupled from the intermediate circuit by step b), since active discharging can be carried out effectively and quickly in this case.

According to a preferred embodiment of the present disclosure, a computing unit configured to perform a method according to the present disclosure is provided.

According to a preferred embodiment of the present disclosure, a mobile work machine is provided comprising a computing unit according to the disclosure and a high-voltage system comprising a voltage source, an intermediate circuit connected to the voltage source and additionally at least two high voltage components connected to the intermediate circuit, which components are configured to exchange power with the intermediate circuit.

According to a preferred embodiment of the present disclosure, a computer program is provided that causes a computing unit to perform a method according to the present disclosure when executed on the computing unit.

### BRIEF DESCRIPTION OF THE DRAWINGS

The present disclosure is described with reference to the accompanying figures, wherein the same reference numbers refer to the same parts and/or similar parts and/or corresponding parts of the system. Regarding the figures:

FIG. 1 schematically describes the structure of a high-voltage system of a mobile work machine for an exemplary embodiment of the disclosure.

FIG. 2 schematically describes the sequence of deactivating the high-voltage system of a mobile work machine for an exemplary embodiment of the disclosure.

### DETAILED DESCRIPTION

In the following, the present disclosure is described with reference to certain embodiments as shown in the accompanying figures. Nonetheless, the present disclosure is not limited to the particular embodiments described in the following detailed description and shown in the figures, but the described embodiments merely illustrate some aspects of the present disclosure, the scope of which is defined by the claims.

Further changes and variations of the present disclosure are clear to those skilled in the art. The present description thus encompasses any amendments and/or variations of the present disclosure, the scope of which is defined by the claims.

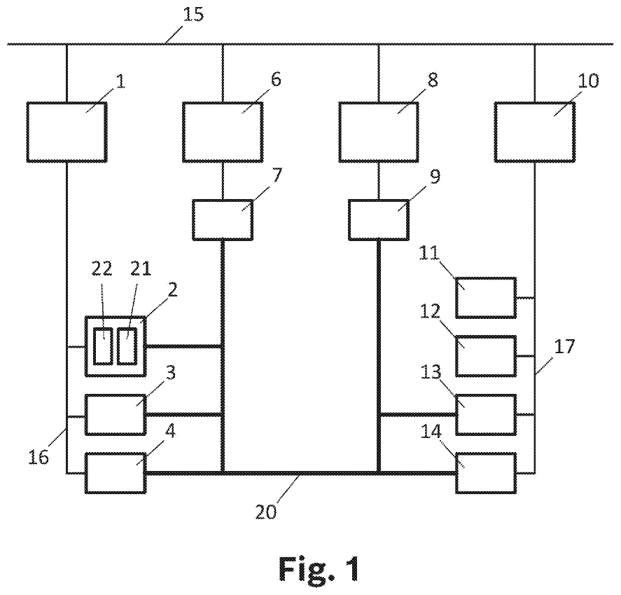

FIG. 1 schematically describes the structure of a high-voltage system of a mobile work machine for an exemplary embodiment of the disclosure.

A high-voltage control unit 1 is network connected to a traction drive control unit 6, a work device control unit 8, and a work machine control unit 10 via a first CAN bus 15. The mentioned control units are configured to exchange electronic messages via the first CAN bus 15, particularly those relating to control of the high-voltage system. In addition, an input device (not shown) of the mobile work machine is connected to the first CAN bus 15.

The high-voltage control unit 1 is network connected to a high-voltage battery 2, a battery charger 3 and a DC-DC converter 4 via a second CAN bus 16. The high-voltage control unit 1 is configured to control said high-voltage components connected to it via the second CAN bus 16 by way of electronic messages.

The high-voltage battery 2 includes battery contactors 21 and a battery management system 22 for controlling the high-voltage battery 2. The battery management system 22 is configured to set the battery contactors 2 to either an open state or a closed state. If the battery contactors 21 are in a closed state, the high-voltage battery 2 provides the intermediate circuit 20 with a high voltage, in this exemplary embodiment a DC voltage of 800 volts. An open state of the battery contactors 21 corresponds to a decoupling of the high-voltage battery 2 from the intermediate circuit 20, because the high-voltage battery 2 does not provide a high voltage to the intermediate circuit 20 in this case.

In this exemplary embodiment, the battery charger 3 is configured as an on-board charger that allows the high-voltage battery 2 to be charged with power from the AC power network.

The DC-DC converter 4 is configured to convert the high voltage of the intermediate circuit 20 to a lower voltage for the low-voltage on-board network (not shown) of the mobile work machine, which may be, for example, 12 Volts. Further components of the mobile work machine can be powered via the low-voltage on-board power system, for example the display unit 11, the already mentioned control units, and coolant pumps of cooling devices (not shown).

The traction drive control unit 6 is connected to a traction drive 7 and is configured to control that traction drive 7. The traction drive 7 includes a first inverter and a first electric motor associated therewith, mechanically coupled to one or more wheels of the mobile work machine. The traction drive 7 is powered by the intermediate circuit 20.

The work device control unit 8 is connected to a work device drive 9 and is configured to control that work device drive 9. The work device drive 9 includes a second inverter, a second electric motor, and a hydropump configured to provide a working pressure mechanism to hydraulic cylinders of a work device. The hydropump may be designed as a constant or adjustable displacement volume hydropump. The work device drive 9 is powered by the intermediate circuit 20.

The work machine control unit 10 is network connected to a display unit 11, a thermal management control unit 12, a high-voltage heater 13, and a high-voltage compressor 14 via a third CAN bus 17. The work machine control unit 10 is configured as a so-called vehicle control unit (VCU) that plays a central role in controlling the mobile work machine. The thermal management control unit 12 is configured to control the high-voltage heater 13 and the high-voltage compressor 14. The high-voltage heater 13 and the high-voltage compressor 14 are powered via the intermediate circuit 20.

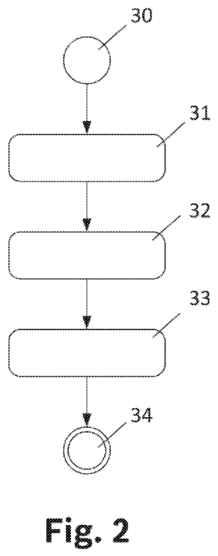

FIG. 2 schematically describes, for an exemplary embodiment of the disclosure, the sequence of deactivating the high-voltage system of a mobile work machine using an activity diagram.

The start node 30 represents the start of the method for deactivating the high-voltage system. Deactivation may be performed by an input from the driver via an input device in the course of a shutdown of the mobile work machine. A request to shut down the mobile work machine may be transmitted from the input device to the work machine control unit 10 via the first CAN bus 15. The work machine control unit 10 may then transmit, via the first CAN bus 15, a request to deactivate the high-voltage system to the high-voltage control unit 1, which may initiate the further steps. A driver-initiated deactivation of the high-voltage system is hereinafter referred to as normal deactivation. In this case, avoiding wear on the high-voltage system has higher priority than deactivating it as quickly as possible.

Alternatively, the deactivation of the high-voltage system may be triggered by detection of a relevant fault in the mobile work machine. This case is hereinafter referred to as forced deactivation, because the deactivation is not triggered by a driver but is due to a fault. As a rule, deactivation as quickly as possible has priority for safety reasons and to avoid damage, as will be described in further detail below. Potentially occurring greater wear on the high-voltage system compared to the normal deactivation is accepted. Detection of a relevant fault is preferably reported to the high-voltage control unit 1, so that the high-voltage control unit 1 can take over further coordination of the deactivation in this case as well. For example, forced deactivation may be triggered by detection of a defect in the insulation by an insulation monitoring device. Detection of such a fault may be reported by the insulation monitoring device to the high-voltage control unit 1, for example via the second CAN bus 16, or it may be reported by the work machine control unit 10.

After the deactivation method has been started, as explained above, the procedure continues with the first action 31. The first action 31 represents the deactivation of the high-voltage components battery charger 3, DC-DC converter 4, traction drive 7, work device drive 9, high-voltage heater 13, and high-voltage compressor 14. This deactivation is coordinated by the high-voltage control unit 1. The high-voltage control unit 1 first transmits the following control commands:
a request, via the first CAN bus 15, to the traction drive control unit 6 to disable the traction drive 7
a request, via the first CAN bus 15, to the work machine control unit 10 to deactivate the high-voltage heater 13, and the high-voltage compressor 14; this request is forwarded from the work machine control unit 10 to the thermal management control unit 12 via the third CAN bus 17, and is then transmitted to the high-voltage heater 13 and the high-voltage compressor 14
a request, via the second CAN bus 16, to deactivate battery charger 3

It may be provided that a control command for deactivating a high-voltage component may have multiple characteristics, for example a first, preferred characteristic for a normal deactivation, and a second characteristic for a forced deactivation of the high-voltage system. For example, the second characteristic of a control command may cause an immediate deactivation of a high-voltage component, whereas the first characteristic requests a deactivation of a high-voltage component where a time delay until actual deactivation is allowed.

Preferably, a successful deactivation of a high-voltage component is reported back to the high-voltage control unit 1 so that a desired deactivation order can be ensured. The deactivation of the traction drive 7 is reported back to the high voltage control unit 1 by the traction drive control unit 6 via the first CAN bus 15. Likewise, deactivation of the high-voltage heater 13 and the high-voltage compressor 14 is reported back to the high volt control unit 1 by the work machine control unit 10. The reporting of the deactivation of the battery charger 3 to the high-voltage control unit 1 occurs via the second CAN bus 16. It may be provided that the high-voltage control unit 1 withdraws enabling of an active state from a deactivated high-voltage component after receiving feedback about the deactivation. In this way, reactivation of the deactivated high-voltage component may be prevented.

In this exemplary embodiment, the steering of the mobile work machine is coupled to the work device drive 9 such that normal steering requires operation of the work device drive 9. As long as the traction drive 7 of the mobile work machine is active, normal steering is to be available for safety reasons. This fact is taken into account in the method according to the disclosure in the order in which the high-voltage components are deactivated: Preferably, the high-voltage control unit 1 does not transmit a control command for deactivation of the work device drive 9 to the work device control unit 8 until a deactivation of the traction drive 7 by the traction drive control unit 6 has been reported. It may be provided, in particular in the event of a forced deactivation, in which the speed of deactivation is usually a priority, for an additional time interval to be taken into account. For example, it may be provided that the high-voltage control unit 1 transmits a control command for deactivating the work device drive 9 at the latest when a first time interval, for example 100 milliseconds, has elapsed since transmitting the control command to deactivate the traction drive 7. In this way, both the preferred order may be considered when deactivating the high-voltage components, and a limit of the maximum time period for that operation may be achieved.

In this exemplary embodiment, it is also provided that the DC-DC converter 4 is deactivated at as late a time as possible, since the DC-DC converter 4 ensures that the low-voltage on-board power system is sufficiently powered. The low-voltage on-board power system supplies power to control units and cooling devices that serve to cool the traction drive 7, work device drive 9, and high-voltage battery 2. Premature deactivation of this cooling would interfere with the operation of said high-voltage components and could result in damage to the high-voltage components. Therefore, the DC-DC converter 4 is preferably only deactivated when the deactivation of the work device drive 9, in addition to the deactivation of the battery charger 3, traction drive 7, high-voltage heater 13, and high-voltage compressor 14, has been reported back to the high-voltage control unit 1 by the work device control unit 8. The deactivation of the DC-DC converter 4 is triggered by a corresponding control command of the high-voltage control unit 1 via the second CAN bus 16. It may be provided that an additional time interval is taken into account. For example, it may be provided that the high-voltage control unit 1 transmits a control command for deactivating the DC-DC converter 4 at the latest when a second time interval has elapsed since the start of the first action 31, for example, 200 milliseconds. In this way, both the preferred order may be considered when deactivating the high-voltage components, and a limit of the maximum time period for that operation may be achieved.

If the DC-DC converter 4 has reported its deactivation to the high-voltage control unit 1, the high-voltage control unit 1 has the information that all high-voltage components have been deactivated, except for the high-voltage battery 2. Thus, it is ensured that each of the power flows between the high-voltage components and the intermediate circuit 20 have been set to zero or a value below a low power threshold. Preferably, as a result, the second action 32 is continued, as in this state it is ensured that the high-voltage battery 2 can be decoupled from the intermediate circuit 20 in a manner that does not cause a lot of wear.

Alternatively, it may be provided to continue with the second action 32 if the power flow between the high-voltage battery 2 and the intermediate circuit 20 has been set to zero or to a value below a low power threshold. However, this alternative is less preferred because it is then not ensured that exchange of power no longer takes place via the intermediate circuit 20. For example, the power flow between the high-voltage battery 2 and the intermediate circuit 20 may be temporarily zero when the current discharged from a high-voltage component and the current received from another high-voltage component temporarily cancel each other out exactly.

It may be provided that an additional time interval may be considered with respect to the start of the second action 32. For example, it may be provided that the second action 32 will continue no later than when a third time interval has elapsed since the start of the first action 31, for example, 300 milliseconds. In this way, the maximum time period for deactivating the high-voltage system may be limited, which may be particularly expedient in the case of a forced deactivation.

The second action 32 represents a decoupling of the high-voltage battery 2 from the intermediate circuit 20. This decoupling may be triggered by a corresponding control command of the high-voltage control unit 1 transmitted to the battery management system 22 of the high-voltage battery 2 via the second CAN bus 16. The battery management system 22 may respond to this control command by opening battery contactors 21. Preferably, the power flows between the high-voltage components and the intermediate circuit 20 were each previously minimized, as described above. In this case, it is ensured that the power flow between the high-voltage battery 2 and the intermediate circuit 20 has also been minimized. The electrical current flowing via the battery contactors 21 is then minimal, so that the opening of the battery contactors 21 occurs with little wear without impermissibly high voltages or currents occurring. It may be provided, in particular, for the forced deactivation of the high-voltage system as described above, that the action 32 is started when a third time interval has elapsed to increase the speed of the method. In this case, it is not ensured that the electrical current flowing via the battery contactors 21 is minimal when the battery contactors 21 are opened. Increased wear on the high-voltage system can result from the occurrence of impermissibly high currents or voltages.

After decoupling the high-voltage battery 2 from the intermediate circuit 20, the procedure continues with the third action 33. The third action 33 represents actively discharging the intermediate circuit 20 and the high-voltage components associated therewith. Active discharging may be triggered by corresponding control commands of the high-voltage control unit 1 to the high-voltage components battery charger 3, DC-DC converter 4, traction drive 7, work device drive 9, high-voltage heater 13, and high-voltage compressor 14 transmitted via one or more CAN buses, as described above for other control commands. Active discharging of the high-voltage components may occur via discharging resistors. After the voltage of the intermediate circuit 20 has been set by active discharging to a value below a voltage limit, preferably below 60 Volts, the end node 34 of the activity diagram, representing the completion of the method, is reached.

While the present disclosure has been described with reference to the embodiments described above, it is clear to those skilled in the art that it is possible to realize various modifications, variations and improvements of the present disclosure in light of the teaching described above and within the scope of the appended claims without departing from the scope of the disclosure.

Moreover, the areas where one skilled in the art is likely to be knowledgeable have not been described herein in order to avoid unnecessarily obscuring the disclosure described.

Accordingly, the disclosure is not intended to be limited by the specific illustrative embodiments, but only by the scope of the appended claims.

What is claimed is:

1. A method for deactivating a high-voltage system of a mobile work machine, wherein the high-voltage system includes a voltage source, an intermediate circuit connected to the voltage source, and at least two high-voltage components connected to the intermediate circuit, which components are configured to exchange power with the intermediate circuit, the method comprising the following steps, initiated in the order indicated:
a) deactivating the at least two high-voltage components so that power flows between the high-voltage components and the intermediate circuit are minimized, wherein deactivating occurs at least partially sequentially in an order;
b) deactivating the voltage source and/or decoupling the voltage source from the intermediate circuit; and
c) actively discharging the intermediate circuit and associated high-voltage components so that a voltage of the intermediate circuit is set to a value below a voltage limit.

2. The method according to claim 1, wherein the voltage source is configured as a battery or as a power converter.

3. The method according to claim 1, wherein at least two of the high-voltage components depend functionally on one another such that deactivating a first high-voltage component impairs a function of a second high-voltage component.

4. The method according to claim 1, wherein, in step a), at least one high-voltage component is deactivated depending on the progress of deactivating another high-voltage component.

5. The method according to claim 1, wherein, in step a), at least one high-voltage component is deactivated while taking into account a time interval.

6. The method according to claim 1, wherein, in step b), the decoupling of the voltage source from the intermediate circuit is caused by the opening of at least one contactor.

7. The method according to claim 1, wherein step b) is performed when step a) has caused each of the power flows between the at least two high-voltage components and the intermediate circuit to be set to zero, or to a value below a power threshold.

8. The method according to claim 1, wherein step b) is performed when step a) has caused the power flow between the voltage source and the intermediate circuit to be set to zero or to a value below a power threshold.

9. The method according to claim 1, wherein step b) is performed at the latest when a specified time interval has elapsed since the execution of step a).

10. The method according to claim 1, wherein, in step c) the voltage limit for actively discharging the intermediate circuit is in a range of 50 Volts to 70 Volts.

11. The method according to claim 1, wherein step c) is performed when the voltage source has been deactivated or decoupled from the intermediate circuit by step b).

12. A computing unit configured to carry out the method according to claim 1.

13. A mobile work machine, comprising:
the computing unit according to claim 12; and
a high-voltage system comprising a voltage source, an intermediate circuit connected to the voltage source, and at least two high-voltage components connected to the intermediate circuit, which components are configured to exchange power with the intermediate circuit.

14. A computer program causing a computing unit to carry out the method according to claim 1 when executed on the computing unit.

15. The method according to claim 10, wherein, in step c) the voltage limit for actively discharging the intermediate circuit is 60 Volts.
